(19) United States
(12) Patent Application Publication
(10) Pub. No.: US 2017/0335143 A1
(43) Pub. Date: Nov. 23, 2017

(54) SELF-ADHESIVE FILM FOR FIXING AN ELASTOMER PATCH AND METHOD FOR REPAIRING A MOTOR VEHICLE TIRE OR FOR CONNECTING TWO LAYERS OF AN ELASTOMER LINING

(71) Applicant: Rema Tip Top AG, Poing (DE)

(72) Inventor: Patric Scheungraber, Pliening (DE)

(21) Appl. No.: 15/520,258

(22) PCT Filed: Oct. 20, 2015
(86) PCT No.: PCT/EP2015/074224

§ 371 Date: Apr. 19, 2017

(30) Foreign Application Priority Data
Oct. 20, 2014 (DE) 10 2014 221 253.7

(51) Int. Cl. C09J 7/02; B29C 73/10; B29L 30/00

(52) U.S. Cl. CPC C09J 7/0214; B29C 73/10; C09J 2400/263; C09J 2201/622; B29L 2030/00; C09J 2400/283; C09J 2400/226

(57) ABSTRACT

The invention relates especially to a self-adhesive film 1 for fixing an elastomer patch 10 during a vulcanization of an elastomer component. The elastomer component can in particular be a motor vehicle tire 40 or a cavity lining 120. The film 1 can comprise a supporting layer 2 and an adhesive layer 3. The adhesive layer 2 can have a predetermined manufacturing adhesiveness at room temperature and ambient pressure and a predetermined peel strength at a vulcanization pressure and a vulcanization temperature.

The present invention relates to a self-adhesive film and a method for repairing a motor vehicle tire or for connecting two layers of an elastomer lining. The self-adhesive film distinguishes itself in that it is suitable to fix an elastomer patch during the vulcanization of an elastomer component or a plurality of elastomer components to one another. The elastomer component and/or the elastomer components are preferably motor vehicle tires or cavity linings of tank trucks or tank wagons.

The repair of damaged vehicle tires, which are damaged in the tread or side wall region, is usually conducted in such a way that what is called a “funnel” is initially cut and filled with raw rubber. Then, the reinforcing supports discontinued in the damaged region are bridged by means of a repair patch which contains corresponding reinforcing supports. In order to complete the repair, the tire with the repaired damaged site and the applied repair patch is vulcanized in an autoclave. This is carried out at predetermined pressure and temperature values.

According to the previously known repair/retreading methods it is necessary to wrap on the outside, and optionally on the inside, around the tire what is called an envelope which fixes the repair patch during the vulcanization at the predetermined position on the tire. The so-called envelope is usually made of flexible elastomer/plastic material, as a result of which this envelope can abut against the outer contour and/or inner contour of the tire. For this purpose, the previously known methods also produce a vacuum between tire and envelope. As already described, the technical purpose of the envelope is inter alia to hold the repair patch in place and prevent disbonding of the repair site as a result of the applied atmospheric pressure during the vulcanization, which might otherwise lead to a peeling of the repair patch.

Furthermore, elastomer linings of tank trucks or tank wagons which transport e.g. corrosive chemicals are produced in such a way that layers of inner and/or elastomer linings are arranged to one another and then adhered to and/or vulcanized with one another. This also requires elaborate preparations and processing steps to securely hold the connecting sites between two lining parts at a predetermined position during the vulcanization. Gaps between two lining elements would be fatal insofar as transported chemicals might attack the outer shell of the tank truck or tank wagon.

The above described methods are complex and time-consuming when carried out. In particular, the assembly of an envelope and the production of a vacuum between the tire and the envelope is time-consuming and inconvenient.

An object of the present invention is to provide a self-adhesive film which is easy to handle as a replacement of the envelope in order to securely fix an elastomer patch during a vulcanization of an elastomer component and a method for repairing an elastomer component and/or for connecting two elastomer components, which guarantee maximum reliability of the repair and/or the connection and are less elaborate and complex as far as their implementation is concerned.

The above mentioned object is achieved by the invention according to the independent claims. Preferred developments are described in the dependent claims.

A self-adhesive film according to the invention can be suitable to fix an elastomer patch during a vulcanization of an elastomer component. The elastomer component is preferably a motor vehicle tire or an element of a cavity lining of a tank truck or tank wagon. The term “elastomer patch” refers in particular to a planar element made of elastomer or to a planar element which has at least one elastomer material portion. Most preferably, the term “elastomer patch” describes a repair patch or repair strip for the repair of a motor vehicle tire.

The self-adhesive film can have a supporting layer which can have a predetermined temperature resistance and can be connected to an adhesive layer. The adhesive layer can have an adhesive and a manufacturing adhesiveness predetermined at room temperature and ambient pressure. The adhesive layer can have a predetermined peel strength and/or a predetermined sealing property under vulcanization conditions, in particular at vulcanization pressure and vulcanization temperature.

The above mentioned self-adhesive film according to the invention has the advantage that it can fully replace the use of an envelope during the repair and/or retreading of a motor vehicle tire.

For example, the damaged site is initially repaired during the repair of a tire with the film according to the invention and the tire patch/tire repair material is applied to the damaged site. Instead of an envelope, the self-adhesive film is then used and adhered to the elastomer patch in such a way that the peripheral areas of the self-adhesive film protrude from the lateral edges of the elastomer patch. In the region of the protruding peripheral areas, the film adheres to the tire surface and seals the repair site and/or, in the subsequent vulcanization operation in the autoclave, fixes the elastomer patch at its position at the tire.

In other words, the former work steps of applying an envelope and of producing a vacuum between tire and envelope can be fully replaced by applying the self-adhesive film. The self-adhesive film also has the advantage that it can be applied and removed again very easily and with little effort and the elastomer patch is securely fixed to the tire on account of its temperature resistance and the predetermined peel strength.

The predetermined temperature resistance of the supporting layer shall here indicate in particular a maximum temperature where the supporting layer still has sufficient coherence to connect the elastomer patch to the tire and/or hold it thereat. The predetermined temperature resistance preferably indicates the transition of the material of the supporting layer to the thermoplastic region when the supporting layer consists of polymer, in particular a thermoplastic material.

The predetermined temperature resistance of the supporting layer is preferably 5 K to 10 K above the vulcanization temperature at vulcanization pressure. The predetermined temperature resistance is most preferably between 90° C. and 180° C.

The adhesive layer can also have an adhesive and is more preferably formed by the adhesive as such. The term “predetermined manufacturing adhesiveness” and/or “manufacturing adhesiveness” shall refer to an inherent adhesiveness and/or adhesive force to the described substrate.

In other words, the term “manufacturing adhesiveness” is the ability of two surfaces of the same or of different materials to form a strong bond upon contact, said bond counteracting the separation of the surfaces. The force necessary for the separation can be indicated for the quantitative characterization of this property, the separating conditions having to be defined depending on the fracture-mechanical knowledge and criteria which are specific to the use.

A so-called peel strength or separation value which is associated with the manufacturing adhesiveness can preferably be determined according to the examination procedure on the basis of DIN EN28510-1 and/or DIN EN ISO 8510-2.

The room temperature according to the claims shall comprise in particular a temperature window of about 15° C. to 25° C. The ambient pressure is preferably between 0.9 bar and 1.1 bar.

The vulcanization conditions, i.e. in particular the vulcanization pressure and the vulcanization temperature, are preferably between 1 bar and 10 bar as regards the vulcanization pressure, and the vulcanization temperature is preferably between 90° C. and 170° C.

The predetermined peel strength according to the claims refers preferably to the force which is necessary to separate the self-adhesive film from the elastomer component by peeling. According to the invention, the value of this predetermined peel strength shall preferably be large enough for the self-adhesive film to be able to reliably hold the elastomer patch at the selected position. The predetermined peel strength (at vulcanization pressure and vulcanization temperature) is preferably between 0.5 N/mm and 10 N/mm and more preferably between 1 N/mm and 5 N/mm.

The predetermined sealing property of the self-adhesive film holds the elastomer patch at the selected position, preferably during the vulcanization. The holding force which is produced by the sealing property is based in particular on the fact that the vulcanization pressure which is built up during the vulcanization in an autoclave acts on the self-adhesive film and can form a pressure difference with respect to the coated region which produces the holding force in the direction of the component to be vulcanized. In other words, the “holding” of the repair patch during the vulcanization and/or the initial phase thereof is based in particular on the sealing in the peripheral region of the self-adhesive film, and therefore the vulcanization pressure in the autoclave and/or a pressure difference presses on the film, thus building up a mechanical pressure. Therefore, the sealing property leads to a preferably additional holding force which can fix the elastomer patch to the component.

Furthermore, the area of the supporting layer and the area of the adhesive layer can have the same size. In addition, the area of the self-adhesive film can be large enough for the self-adhesive film to protrude in each case from the lateral edges of the elastomer patch when the self-adhesive film is adhered to the elastomer patch. The lateral edges of the self-adhesive film preferably protrude from the lateral edges of the elastomer patch with a predetermined length when the centers of the self-adhesive film and the elastomer patch are arranged on top of one another. The predetermined length with which the self-adhesive film and/or the edges thereof protrude, is preferably between 5 mm and 10 cm and is more preferably 10 mm to 5 cm and most preferably 20 mm to 3.5 cm. The sealing property can be adjusted inter alia by means of the length of the protruding lateral edges of the self-adhesive film, wherein the sealing property can increase with a larger protrusion.

The “predetermined sealing property” shall mean in particular that a predetermined pressure difference can be achieved between the region coated by adhesion using the self-adhesive film and the vulcanization pressure. At a maximum vulcanization pressure, the predetermined pressure difference is preferably between 0.05 bar and 10 bar and more preferably between 0.1 bar and 5 bar. The sealing property can preferably be adjusted by means of the above described length of the protruding peripheral regions, the thickness of the adhesive layer, the mass of the adhesive and/or the gas tightness of the selected material of the supporting layer.

The above mentioned properties of the self-adhesive film guarantee a secure support of the elastomer patch on the elastomer component in particular during the entire vulcanization period, as a result of which a reliable connection can be formed between the elastomer component and the elastomer patch.

Furthermore, the adhesive can contain rubber, solids and tackifiers. Most preferably, the solids are resins and the tackifiers are chemical mixtures to increase the surface adhesiveness of rubber components and/or elastomer components. For example, the tackifiers can contain resinous materials which are converted into dispersions and/or emulsions.

For example, the adhesive can contain 20% to 70% of masticated natural rubber and e.g. 2% to 10% of liquid polyisoprene rubber. Furthermore, it is possible to provide 1% to 10% of resins. Further mixture components can be soot, silica, chalk and sulfur, retarding agents or accelerators and/or zinc oxide, plasticizers, stearic acid and/or aging protectants.

More preferably, the adhesive can also have a butyl portion. When the adhesive also has a butyl portion, the tire surface roughened in the peripheral region of the repair site is simultaneously sealed during the vulcanization since the butyl portion of the adhesive bonds with the surface during the vulcanization, thus leading to sealing.

The thickness of the adhesive layer can be between 5 μm and 500 μm and preferably has a thickness between 15 μm and 200 μm. Most preferably, the thickness ranges from 20 μm to 25 μm. The above mentioned thickness of the adhesive layer renders possible both a maximum flexibility of the self-adhesive film, as a result of which this film can abut well against the outer contours of the damaged site and the elastomer patch, and an optimum seal and/or sealing property against the external atmosphere is simultaneously achieved when the self-adhesive film is adhered to the elastomer component.

In addition to the property of producing an adhesion, the adhesive layer also has a sealing effect and/or the predetermined sealing property which preferably seals the elastomer patch coated by adhesion using the self-adhesive film against the external atmosphere in gas-tight fashion. For this purpose, the adhesive layer can comprise a specific mass of adhesive between 10 g/m² and 200 g/m² (based on the area of the supporting layer). The specific mass of adhesive is more preferably 10 g/m² to 150 g/m² and most preferably 10 g/m² to 100 g/m².

As already explained above with respect to the thickness of the adhesive layer, the mass of adhesive is a factor that a sufficient bond can be formed between the self-adhesive film and the elastomer component and a secure sealing effect against the external atmosphere can simultaneously be produced.

The supporting layer of the self-adhesive film can preferably include a polymer. Alternatively, the supporting layer can also be made of paper or fabric, which is soaked with a polymer. An important property of the supporting layer is to seal the covered elastomer patch against the external atmosphere in addition to mechanically holding the adhesive layer. In other words, the supporting layer must have a high gas-tightness. When the supporting layer is made of polymer, in particular polyamide, polypropylene or polyethylene are preferred, which simultaneously have the above mentioned temperature resistance. When the supporting layer is made of paper or fabric, a polymer impregnation is carried out with respect to the desired gas tightness and/or the predetermined sealing property. In addition to the above mentioned properties, the supporting layer is also very flexible so as to render possible an optimum contour adaptation to the elastomer patch and the tire surface and in the general use.

Furthermore, the adhesive layer can also be combined with a second functional layer which is directly applied to the supporting layer, as a result of which the adhesive layer rests on this second functional layer. In other words, a further layer or a plurality of further layers can be provided between the supporting layer and the adhesive layer. The second functional layer can be e.g. a further elastomer layer. The second functional layer can also be made of the same material as the supporting layer. The second functional layer can have e.g. a graphic print which serves as a positioning aid. For example, lines, circles, frames or the like can be used for this purpose to facilitate the alignment and/or positioning of the self-adhesive film.

In addition, the self-adhesive film can be provided with an adhesive over the entire surface or only in some regions. In the case of a partial application of adhesive, the partially applied adhesive layer can have e.g. planar patterns which combines uncovered subareas and subareas covered with adhesive. Therefore, the adhesive can also be applied in a cost-effective way.

In addition, the adhesive film can be permanently connected e.g. to the tire surface, remain on e.g. the tire surface after the vulcanization and the removal of the film and additionally seal said tire surface. This saves (further) work steps as regards the subsequent treatment of the vehicle tire (or the elastomer lining), thus reducing the amount of work.

As regards an assembly that shows very little complexity and is time-saving, the self-adhesive film can also be transparent. Furthermore, the self-adhesive film can have a protective layer and/or a protective ply on the adhesive layer opposite the supporting layer, which protects the adhesive layer against aging during storage. The protective layer can be removed from the adhesive layer before the film is used.

In addition, the invention comprises a method for repairing a motor vehicle tire, a damaged site of an elastomer lining or for connecting two layers of elastomer lining. The layers of elastomer lining can preferably be arranged in an adjoining fashion. Alternatively, the layers can be arranged in overlapping fashion. The method according to the invention can initially comprise the step of applying the elastomer patch to the repaired damaged site of the tire or the damaged site of the elastomer lining or arranging the two layers of elastomer lining in relation to one another in such a way that the two layers adjoin one another at a seam or overlap at a seam. Thereafter, it is optionally possible to apply an elastomer patch to the seam. After the elastomer patch was applied to the damaged site of the tire or optionally also to the seam, the elastomer patch or the seam can be coated by adhesion using the self-adhesive film according to the invention. The coating step can be carried out in such a way that the self-adhesive film protrudes in each case from the lateral edges of the elastomer patch or fully covers the seam. Having adhered the self-adhesive film, the vulcanization can be carried out. For this purpose, the necessary pressure and temperature measurements can be made and used and/or maintained for a predetermined period of time.

Therefore, the method according to the invention has the advantage that the effort for preparing the vulcanization can be markedly reduced and abbreviated. It is less complex and does not require any further components or auxiliary means, such as an envelope or the like, to coat by adhesion the elastomer patch and/or the seam using the self-adhesive film.

After the vulcanization, the film can be removed and before the vulcanization a protective layer can be removed from the adhesive layer of the film which can protect the adhesive layer of the film against aging and soiling.

In summary, a self-adhesive film and a method for repairing an elastomer component or for connecting two elastomer components are described which markedly reduce the manufacturing and repair effort.

The invention is described by way of example below with reference to the enclosed schematic drawings, wherein:

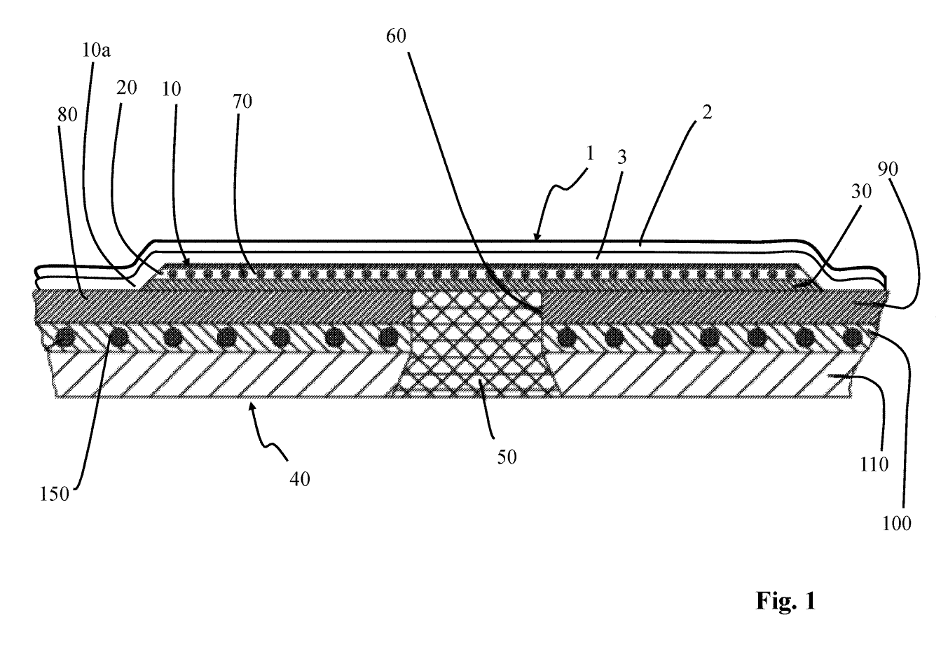

FIG. 1 shows a sectional view of a self-adhesive film which is mounted on a tire surface,

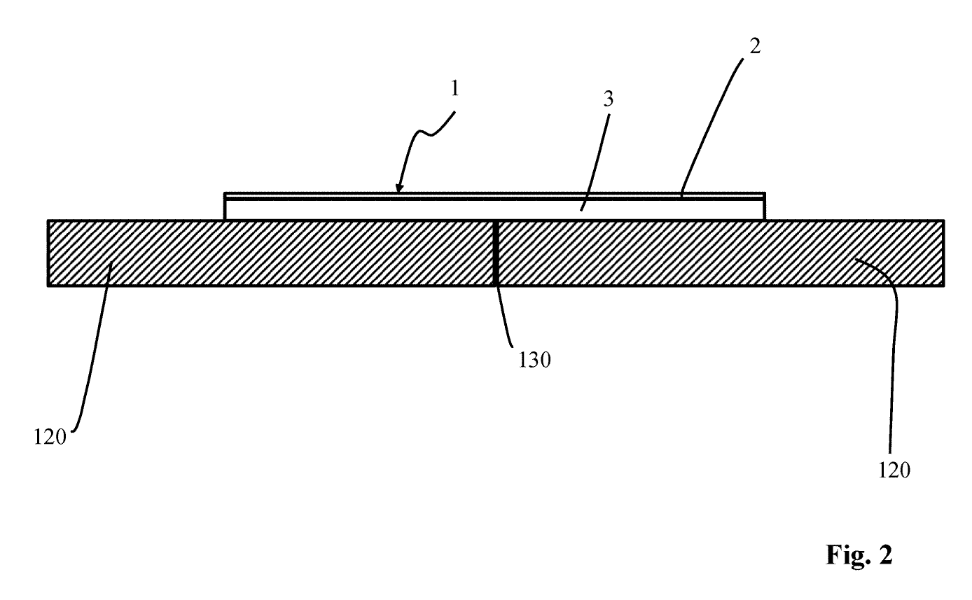

FIG. 2 shows a sectional view of a self-adhesive film which is mounted on a cavity lining, and

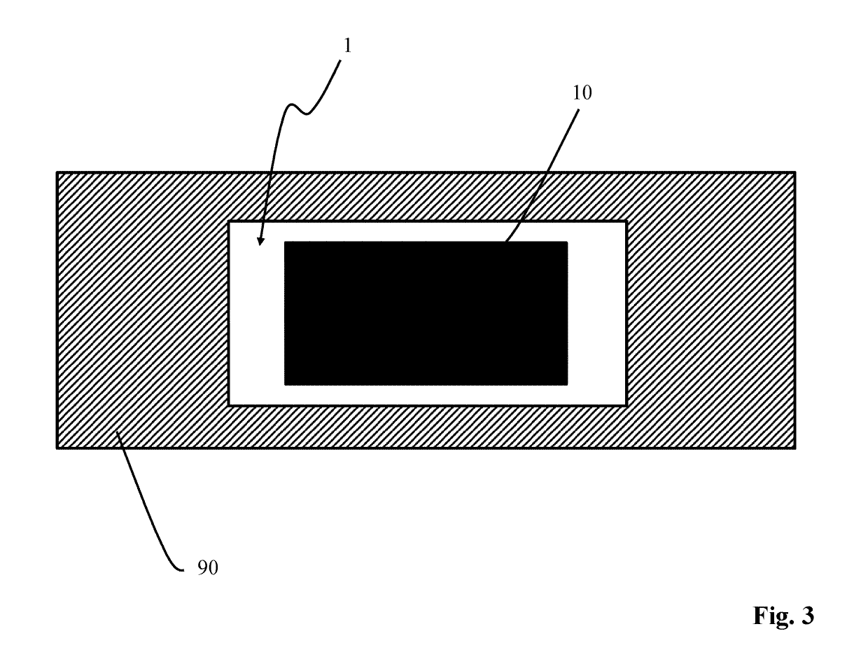

FIG. 3 shows a top view of the self-adhesive film.

Various examples of the present invention are described in detail below with reference to the drawings. Equal and/or similar elements in the drawings are here designated by equal reference signs. However, the present invention is not limited to the described design features but comprises further modifications of features of the described examples and combinations of features of various examples within the scope of protection of the independent claims.

FIG. 1 shows a sectional view through a tire 40 having a repaired damaged site 60, to which a tire repair patch 10 is adhered. The illustrated section of the tire 40 has a layer of lateral wall rubber 110, the carcass 100 with fibrous inserts 150 and an inner liner 90. This figure also shows the (self-adhesive) film 1 according to the invention, which was adhered above the tire repair patch 10.

The illustrated damaged site 60 is filled with raw rubber 50. Preferably and as shown, the tire patch and/or the tire repair patch 10 has a sticky connecting layer 30, which holds the tire repair patch 10 in connection to the illustrated inner liner 90 of the tire 40. A further layer of the tire repair patch 10 is a rubber layer 20 having supporting elements 70, such as steel or carbon fiber filaments.

During the vulcanization, internal stresses are released in the tire repair patch/the repair site together with an initial viscosity drop of the initially still unvulcanized connecting layer, which may lead to the peeling of the tire repair patch 10 from the surface 90. Therefore, envelopes were formerly wrapped around the tire 40 and the tire repair patch 10, and a vacuum was applied, which hold the tire repair patch 10 at the predetermined position on the tire surface 90. According to the invention, this is no longer necessary in a technically advantageous manner since the film 1 shown in FIG. 1 adopts the technical function of the envelope on the inner side of the tire.

The illustrated film 1 has an adhesive layer 3, which establishes a connection between the inner liner 90 and the film 1. The adhesive layer 3 is arranged on a preferably polymer-based supporting layer 2. The self-adhesive film 1 according to the invention is very flexible and, as shown, adapts itself in optimum fashion to the outer contour of the tire repair patch 10 and the contour of the inner liner 90.

The film 1 protrudes in each case from lateral edges 10a of the tire repair patch 10 (see FIG. 3) in such a way that the tire repair patch 10 is fixedly held in place during the vulcanization inter alia on account of the adhesive connection between the film 1 and the inner liner 90 and/or the uppermost layer of the tire repair patch 10. Furthermore, the film 1 shall not allow a gas exchange between a cavity in which the tire repair patch 10 is arranged and an outer side of the film 1. Correspondingly, the illustrated supporting layer 2 is preferably gas-tight and the adhesive layer 3 also adopts, in addition to the adhesive function, a sealing function against the external atmosphere. This sealing property of the self-adhesive film can produce a pressure difference of e.g. 0.05 bar or more in the region coated by adhesion with respect to the external atmosphere, which has an increased pressure of e.g. 5 bar during the vulcanization. This possible pressure difference produces an (additional) holding force which acts in the direction of the surface of the elastomer component and, together with the elastomer patch, presses the self-adhesive film securely and reliably against the component, in particular during the vulcanization.

The vulcanization conditions usually range from 1 bar to 10 bar pressure and are at a temperature of about 90° C. to 180° C. These conditions are preferably maintained during a period of about 60 min to 10 h. During this period and with the above mentioned temperature and pressure conditions, the self-adhesive film 1 has a peel strength of at least 0.5 N/mm between the inner liner 90 and/or the uppermost layer of the tire repair patch 10 and the adhesive layer 3, as a result of which the tire repair patch 10 cannot be detached.

The adhesive layer 3 preferably has a portion of 20% to 70% of masticated natural rubber. Furthermore 2% to 10% of liquid polyisoprene rubber can be contained and up to 10% of resins in order to achieve the above mentioned peel strength. Further constituents can also be solids, such as soot, silica or chalk. When the adhesive layer 3 has a butyl portion, the inner side of the tire which is covered by the film is also sealed during the vulcanization at the same time.

The method for applying the self-adhesive film 1 and/or for repairing the tire 40 or the elastomer lining comprises substantially the steps of repairing the damaged site 60 and of filling the damaged site 60 with raw rubber 50. Furthermore, the tire repair patch 10 is applied to the filled damaged site 50, 60 and the tire repair patch 10 is coated by adhesion using the film 1 according to the invention. Then, the vulcanization is carried out as usual and previously known.

FIG. 2 shows the film 1 according to the invention, which is not adhered to a tire repair patch 10 of a motor vehicle tire 40 but over a seam 130 of two layers of elastomer lining 120. Large tank trucks or tank wagons have an elastomer lining 120 to protect the outer shell in order to be able to transport e.g. corrosive chemicals. The layers of elastomer lining 120 can either overlap one another or be arranged edge to edge. FIG. 2 shows by way of example an edge-to-edge arrangement. For the purposes of a repair of the lining, it is also possible to adhere an elastomer patch 10′ which is not shown in FIG. 2 to the elastomer lining 120, said patch having a similar structure as the repair patch 10 of FIG. 1. In order that the two layers of elastomer lining 120 do not leave the predetermined position during the vulcanization or in order that the elastomer patch 10′ is not detached during the vulcanization, the film 1 according to the invention is adhered to the seam 130 or the elastomer patch 10′.

As regards the connection of two layers of elastomer lining 120, the layers can also be connected to one another without using an elastomer patch 10′, as described. Should the layers be arranged in such a way that they overlap one another, the seam 130 can directly be coated by adhesion using the film 1, i.e. without repair patch 10′. The two layers of elastomer lining 120 bake together during the vulcanization. Furthermore, the layers of the elastomer lining 120 can also be arranged edge to edge. In this arrangement, too, the seam 130 can directly be coated by adhesion by means of the film 1 without using a repair patch 10′. In this case, the edge end faces of the two layers of elastomer lining 120 are joined during the vulcanization. In addition, the seam 130 can also be filled with raw rubber 50′ so as to produce in an even more reliable way a closure of the seam 130 which is as complete and continuous as possible.

FIG. 3 shows a top view of the arrangement in FIG. 1, which comprises the tire 40, the tire repair patch 10 and the film 1. FIG. 3 shows in particular that the film 1 protrudes on all lateral portions of the tire repair patch 10 from said portions, as a result of which an adhesive connection can be produced between the film 1 and the inner liner 90. Since the film shown schematically in FIG. 3 is transparent, the illustration should be comprehended in such a way that the film 1 extends continuously inside the area shown in white and here above the repair patch 10 shown in black. FIG. 3 shows by way of example a rectangular base of the repair patch 10 and the film 1. Other possible shapes comprise round, elliptic or square shapes of the base. The shape of the base of the repair patch 10 can also differ from the shape of the base of the film 1. Furthermore, FIG. 3 shows that the protruding portions of the film 1 have different widths in the longitudinal and transverse directions. The protruding portions can also have equal width.

Finally, it should be noted that the invention describes a method and a self-adhesive film 1, which considerably simplifies the repair of a tire 40 or an elastomer lining and/or the connection of two elastomer layers of an elastomer lining 120.

1-11. (canceled)

12. A self-adhesive film for fixing an elastomer patch during a vulcanization of an elastomer component, in particular of a motor vehicle tire or a cavity lining, the self-adhesive film comprising:
a supporting layer which has a predetermined temperature resistance and which is connected to an adhesive layer; and
the adhesive layer which has an adhesive;
wherein the adhesive layer has a predetermined manufacturing adhesiveness at room temperature and ambient pressure, and the adhesive layer has a predetermined peel strength and a predetermined sealing property under vulcanization conditions.

13. The self-adhesive film of claim 12 wherein the adhesive contains rubber, solids, in particular resins, and tackifiers, the adhesive optionally having a butyl portion.

14. The self-adhesive film of claim 12 wherein the thickness of the adhesive layer is between 5 and 500 μm and/or a specific mass of adhesive, which includes the adhesive layer on the basis of an area of the supporting layer, is between 10 and 200 g/m².

15. The self-adhesive film of claim 12 wherein the supporting layer has a polymer or elastomer, in particular a polyamide, polyethylene or a rubber film, or the supporting layer includes paper or a fabric which is soaked with a polymer.

16. The self-adhesive film of claim 12 wherein the self-adhesive film is provided with an adhesive over the entire surface or only in some regions.

17. The self-adhesive film of claim 12 wherein the size of the area of the supporting layer and that of the adhesive layer are equal, the area being adapted to such a size that the self-adhesive film protrudes in each case from the lateral edges of the elastomer patch with a predetermined length.

18. The self-adhesive film of claim 12 wherein the adhesive layer and/or the adhesive is permanently connected to the tire surface, remains on the tire surface after the vulcanization and the removal of the film and additionally seals said surface.

19. The self-adhesive film of claim 12 wherein a protective layer is arranged on the adhesive layer and opposite the supporting layer, which can be removed from the adhesive layer before the film is used.

20. A method for repairing a motor vehicle tire or for connecting two layers of elastomer lining, the method comprising:
applying an elastomer patch to a repaired damaged site of a tire/elastomer lining or arranging two layers of an elastomer lining in relation to one another in such a way that the two layers adjoin one another at a seam;
coating the elastomer patch and/or the seam by adhesion using a self-adhesive film comprising:
a supporting layer which has a predetermined temperature resistance and which is connected to an adhesive layer, and
the adhesive layer which has an adhesive,
wherein the adhesive layer has a predetermined manufacturing adhesiveness at room temperature and ambient pressure, and the adhesive layer has a predetermined peel strength and a predetermined sealing property under vulcanization conditions;
wherein the elastomer patch and/or the seam are coated with adhesive in such a way that the film protrudes in each case from the lateral edges of the elastomer patch and/or from the seam; and
producing and applying the pressure and temperature conditions required for a vulcanization for a predetermined period of time.

21. The method of claim 20 wherein the film is removed after the vulcanization.

22. The method of claim 20 wherein a protective layer is removed from the adhesive layer of the film prior to the coating of the film by adhesion.
